(19) United States
(12) Patent Application Publication
(10) Pub. No.: US 2007/0212184 A1
(43) Pub. Date: Sep. 13, 2007

(54) Vehicle load floor with variable friction

(76) Inventor: Christopher E. Borroni-Bird, Oakland Township, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/373,552

(22) Filed: Mar. 10, 2006

(51) Int. Cl. B65F 9/00; B63B 25/00

(52) U.S. Cl. 410/94

(57) ABSTRACT

A load floor for a vehicle is characterized by selectively variable friction characteristics. A high coefficient of friction is selectable to resist movement of cargo on the load floor during vehicle movement, and a low coefficient of friction is selectable to facilitate the movement of cargo on the load floor during loading or unloading.

### TECHNICAL FIELD

This invention relates to vehicle load floors having selectively variable friction characteristics.

### BACKGROUND OF THE INVENTION

Vehicles often include a load floor configured to support cargo in a cargo area. For example, minivans and sport-utility vehicles typically include a cargo area in the rear of the vehicle. Access to the cargo area is provided by a rear body opening that is selectively closed by a rear closure panel, such as a tailgate or a liftgate. Similarly, pickup trucks include a cargo area, i.e., a cargo box, with access to the cargo box being provided by an opening at the rear of the truck and that is selectively closed by a tailgate. The load floor forms the lower surface of the cargo area or cargo box.

Loading cargo into the cargo area may include sliding the cargo on the load floor to push the cargo into a desired position for transport. Some prior art vehicles include movable load floors that are movable rearward outside the body opening for loading cargo, and that are then movable inside the cargo area with the cargo placed thereon.

### SUMMARY OF THE INVENTION

A vehicle is provided that includes a body at least partially defining a cargo area. The vehicle also includes a load floor having a surface that further defines the cargo area. The load floor is characterized by selectively variable friction characteristics. Thus, the load floor may alternately provide a relatively small amount of friction to provide a relatively small amount of resistance to the movement of cargo across the surface, thereby facilitating loading and unloading of the cargo, and a relatively high amount of friction to provide a relatively high amount of resistance to the movement of cargo across the surface, thereby preventing movement of the cargo during vehicle movement.

In an exemplary embodiment, the load floor is configured such that the friction characteristics change as a result of the presence of at least one predetermined condition. For example, if the engine is running, the vehicle is moving, or the ignition switch is in the “on” position, then the load floor increases friction to minimize or prevent movement of cargo during transport. If the engine is not running, the vehicle is at rest, or the ignition switch is in the “off” position, then the load floor decreases friction to allow cargo to more easily slide during loading or unloading.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, perspective view of a vehicle body defining a cargo area, and a load floor further defining the cargo area;

FIG. 2 is a schematic, cross-sectional view of the load floor of FIG. 1 in a first configuration;

FIG. 3 is a schematic, cross-sectional view of the load floor of FIG. 1 in a second configuration;

FIG. 4 is a schematic, top view of an alternative load floor in accordance with the claimed invention;

FIG. 5 is a schematic, cross-sectional view of another alternative load floor in a first configuration; and

FIG. 6 is a schematic, cross section view of the load floor of FIG. 5 in a second configuration.

### DESCRIPTION OF THE PREFERRED EMBODIMENTS

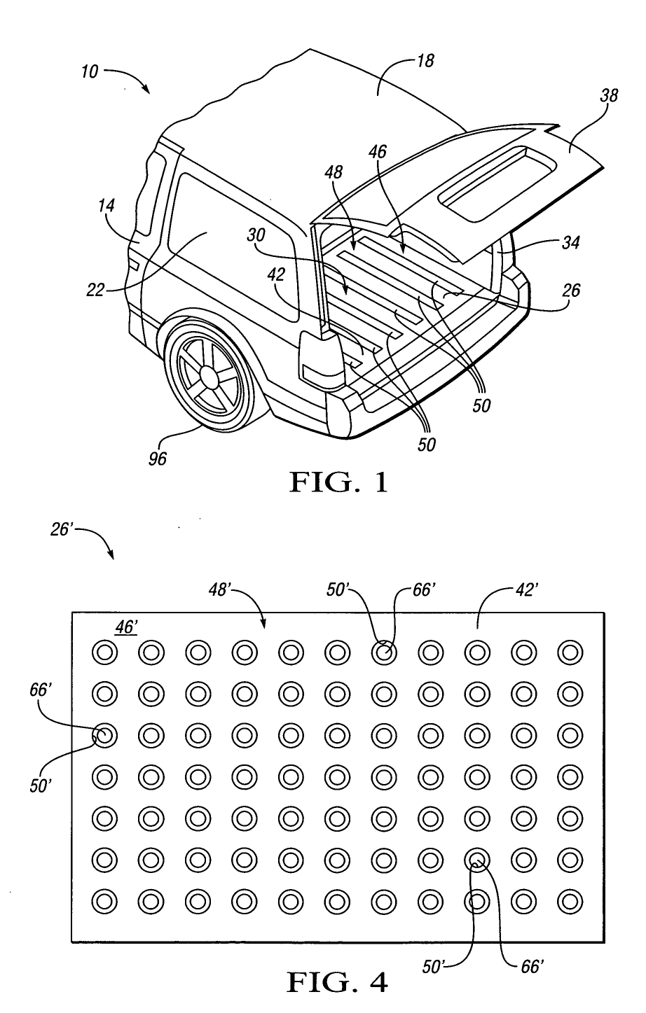

Referring to FIG. 1, the rearward portion of a vehicle 10 is schematically depicted. The vehicle 10 includes a vehicle body 14 having a roof 18, side windows 22, and a load floor 26. The roof 18, side windows 22, and load floor 26 cooperate to at least partially define a rear cargo area 30. The body 14 defines a rear cargo opening 34 through which a vehicle user can access the cargo area 30. A rear closure panel, such as liftgate 38, is movable between an open position (as shown) in which the rear cargo opening 34 is substantially unobstructed, and a closed position (not shown) in which the liftgate obstructs and seals the rear cargo opening 34, as understood by those skilled in the art.

The vehicle body 14 is for a sport-utility style vehicle in the embodiment depicted. However, other body styles defining a cargo area may be employed within the scope of the claimed invention. For example, the vehicle body may be for a minivan, pickup truck, etc. within the scope of the claimed invention.

The load floor 26 includes an upper load floor member 42 that has a surface 46 that forms a first portion of a load floor surface 48 that is exposed to, and defines the lower extent of, the cargo area 30. Within the scope of the claimed invention, an “upper load floor member” may comprise multiple pieces. For example, an upper load floor may include a structural portion formed from stamped metal, and an aesthetic covering, such as carpeting or padding, that defines the surface 46. The member 42 defines a plurality of elongated apertures, namely slots 50 that are longitudinally oriented with respect to the vehicle 10.

FIG. 2, wherein like reference numbers refer to like components from FIG. 1, is a sectional view of the load floor 26 taken about a transverse, vertical plane. The upper load floor member 42 is supported by body structure 54 above a cavity 58 that contains a movable member 60. The movable member 60 includes support plate 62 and a plurality of elastomeric members, i.e., strips 66, that are connected to the upper surface 68 of the support plate 62. The strips 66 form protuberances from surface 68. Each of the strips 66 is aligned with a respective one of the slots 50 formed in the upper load floor member 42. The strips 66 collectively form a second portion 70 of the load floor surface 48.

The movable member 60 is shown in a first position in which the strips 66 are located below the upper surface 66 of the upper load floor member 42, and do not project through slots 50. Thus, when the movable member is in the first position, the strips 66, and therefore the second portion 70 of the load floor surface 48, do not protrude from the surface 46 of the upper load floor member into the cargo area 30. Cargo 71 therefore rests on surface 46 of the upper load floor member 46 and not on the strips 66 or the second portion 70 of the load floor surface 48.

The vehicle 10 includes two actuators 72 that are operatively connected to the movable member 60, and that are configured to selectively move the movable member 60, and correspondingly the support plate 62 and the elastomeric strips 66, up and down. Those skilled in the art will recognize a variety of actuators that may be employed within the scope of the claimed invention, such as servomotors, solenoids, shape memory materials, etc. As understood by those skilled in the art, a shape memory material assumes a predetermined shape when exposed to a stimulus such as heat. The heat may be supplied, for example, by electrical resistance heating of the shape memory material.

More particularly, the actuators 72 are configured to move the movable member 60 from the first position shown in FIG. 2 to a second position shown in FIG. 3. Referring to FIG. 3, wherein like reference numbers refer to like components from FIGS. 1 and 2, the plate 62 and strips 66 are higher with respect to the upper load floor member 42 than in the first position shown in FIG. 2. Each of the strips 66 protrudes from a respective slot 50 so that at least part of each strip 66 extends higher than surface 46 to protrude from surface 46 into the cargo area 30.

Accordingly, cargo 71 rests on the strips 66 of elastomeric material and on the second portion 70 of the load floor surface 48, and not on the surface 46 of the upper load floor member 42. The surface 46 of the upper load floor member 42, i.e., the first portion of load floor surface 48, is characterized by a first coefficient of friction with the cargo 71. The elastomeric strips 66, and correspondingly the second portion 70 of the load floor surface 48, have a second coefficient of friction with the cargo 71 different from the coefficient of friction of surface 46, i.e., the first coefficient of friction. Accordingly, the friction characteristics of the load floor 26 are selectively variable by moving the movable member 60 between the first and second positions.

In the embodiment depicted, the second coefficient of friction is higher than the first coefficient of friction, and therefore the strips 66 provide greater resistance to the movement of cargo 71 thereacross than the surface 46. However, and within the scope of the claimed invention, the portion of the load floor surface defined by the movable member 60 may have a lower coefficient of friction than surface 46. Such a configuration would be desirable if a shape memory material is used as an actuator because energy would be required to maintain the support plate and strips in the second position.

More specifically, if a shape memory material is used as an actuator, the predetermined shape that the material assumes when subjected to the stimulus would likely be such that the shape memory material forces the movable member 60 to the second position. Once the stimulus is removed, the movable member 60 would return to the first position. It is expected that the high friction setting of the load floor would be used more frequently than the low friction setting. Accordingly, to minimize the amount of energy that must be expended to maintain the shape memory material in the predetermined shape, the low friction setting should occur with the movable member in the second position.

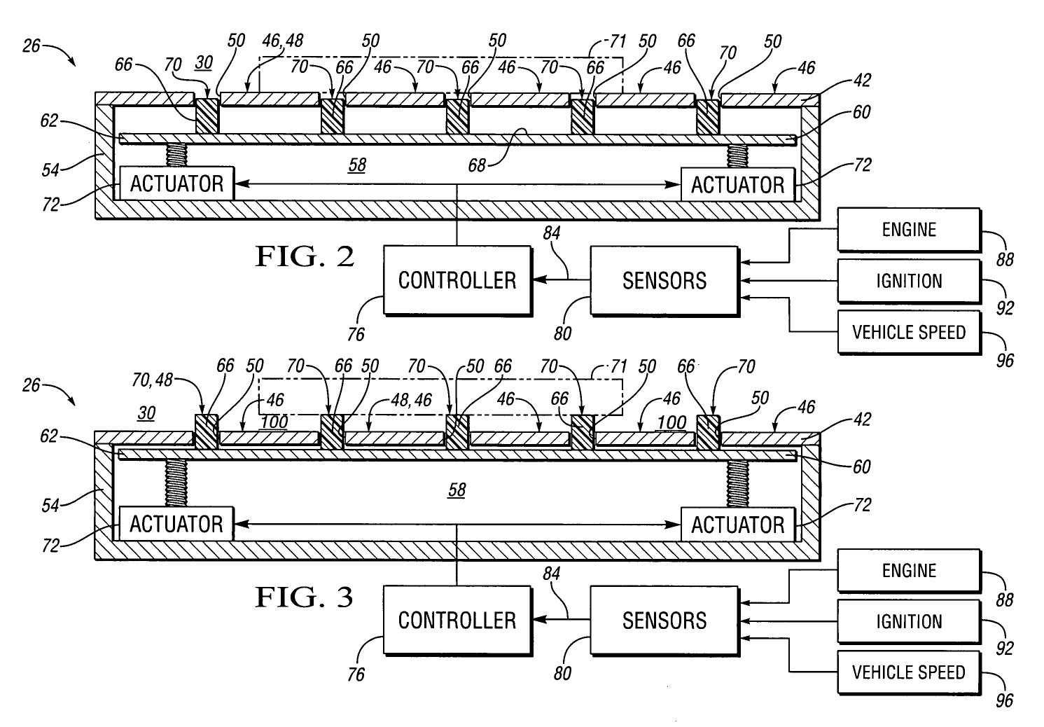

Further, and within the scope of the claimed invention, the movable member 60 may have mechanisms, such as rollers, that replace strips 66 to provide less resistance to the movement of cargo than the surface 46 of the upper load floor member. In an exemplary embodiment, rollers or bearings would define the second portion of the load floor surface, and be attached to the plate 62 to protrude through the apertures 50 when the movable member 60 is in the second position. Referring to FIG. 4, wherein like reference numbers refer to like components from FIGS. 1-3, such an alternative load floor 26′ is schematically depicted. The load floor 26′ includes an upper load floor member 42′ having a surface 46′ that forms a first portion of the load floor surface 48′. The upper load floor member 42′ defines a plurality of circular apertures 50′. Roller elements 66′ are aligned with repsective apertures 50′, and are attached to a movable member (not shown) for movement therewith.

Referring again to FIGS. 2 and 3, the load floor 26 is preferably automated so that the load floor surface 48 provides increased friction for cargo when at least one predetermined condition exists that indicates the vehicle is in motion or motion of the vehicle is likely, and, correspondingly, the load floor 48 provides reduced friction for cargo when the vehicle is at rest and is likely to remain at rest.

More specifically, the load floor 26 includes a controller 76 that is operatively connected to the actuators 72 to selectively cause the actuators 72 to move the movable member 60 between the first and second positions. Sensors 80 are configured to monitor various vehicle components and transmit signals 84 indicative of the status of the components to the controller 76. Exemplary components monitored by the sensors 80 include the vehicle's engine 88, the vehicle's ignition switch 92, and the vehicle's wheels 96. The sensors 80 may also monitor the inclination of the vehicle to determine whether the vehicle is on a hill.

The controller 76 receives signals 84 and determines whether or not a predetermined condition exists, such as the engine 88 running, the ignition switch 92 being in the “on” position, or the wheels 96 rotating. If the controller 76 determines that the predetermined condition exists, then it causes the movable member 60 to move to the second position, as shown in FIG. 3. If the controller determines that the predetermined condition does not exist, e.g., if the engine 88 is not running, the ignition switch 92 is in the “off” position, the wheels 96 are stationary, or the vehicle is not on a hill, then the controller 76 causes the movable member 60 to move to the first position, as shown in FIG. 2.

Thus, if the controller determines that a predetermined condition indicative of vehicle movement exists, such as the engine running, the ignition switch being in the “on” position, or the wheels rotating, or that the vehicle is on an inclined surface, the load floor surface 48 provides a higher level of friction with respect to the cargo 71 to resist movment of the cargo across the load floor surface 48. Otherwise, the load floor surface provides a lower level of friction with respect to the cargo to facilitate movement of the cargo across the load floor surface 48 for loading and unloading. Alternatively, the higher level of friction may be a default condition unless a predetermined condition exists that indicates that cargo is to be loaded or unloaded, such as when the liftgate (shown at 38 in FIG. 1) is open.

Although the load floor depicted is automated, a load floor may be manually operated within the scope of the claimed invention. For example, a switch (not shown) may be operable by a vehicle user to cause the actuators 72 to move the platform between the first and second positions, and thereby cause the friction characteristics of the load floor surface 48 to vary. Similarly, and within the scope of the claimed invention, actuators 72 may be replaced by a manually-operated mechanism, such as a hand crank, a four-bar linkage, etc.

When the movable member 60 is in the second position as shown in FIG. 3, the elastomeric strips 66 cooperate with the floor member 42 to define compartments 100 therebetween. The elastomeric strips 66 may thus function to retain cargo in a respective compartment during vehicle travel. The elastomeric strips 66 and the apertures 50 are arranged longitudinally with respect to the vehicle in the embodiment depicted. However, and within the scope of the claimed invention, the elastomeric strips 66 and the apertures 50 may be arranged transversely with respect to the vehicle so that the strips 66 can retain cargo in a compartment near the liftgate for easy access by a vehicle user. It should be noted that any shape or size may be employed for the apertures 50 and the members 66. For example, the members 66 may form a logo or trademark of the vehicle in which the load floor is installed.

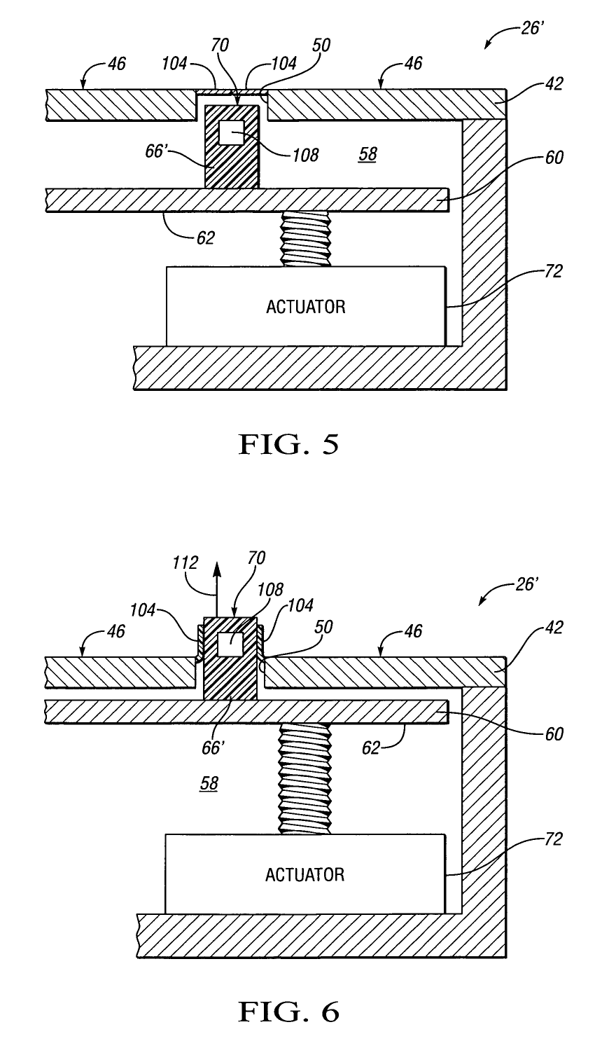

Referring to FIG. 5, an alternative load floor 26′ is schematically depicted. Load floor 26′ is substantially similar to the load floor 26 of FIGS. 1-3, except that flexible flaps 104 are mounted at the upper section of each aperture 50, and each elastomeric strip 66′ is translucent or transparent and includes a light source 108 therein. The flaps 104 substantially close each aperture 50 to provide a flat surface when the movable member 60 is in the first, retracted position. The flaps 104 prevent debris from entering the apertures 50. Those skilled in the art will recognize a variety of light sources that may be employed within the scope of the claimed invention, such as incandescent lamps, fluorescent lights, fiber optics, etc.

Referring to FIG. 6, wherein like reference numbers refer to like components from FIG. 5, each strip 66′ forces the flaps 104 apart to protrude above the surface 46. The light source 104 is configured to selectively transmit light 112 through the strip 66′ and surface 70 and into the cargo area to aid in the loading and unloading of cargo at night.

While the best modes for carrying out the invention have been described in detail, those familiar with the art to which this invention relates will recognize various alternative designs and embodiments for practicing the invention within the scope of the appended claims.

1. A vehicle comprising:
a vehicle body at least partially defining a cargo area;
a load floor including a first member having a surface that further defines the cargo area;
said load floor being characterized by selectively variable friction characteristics.

2. The vehicle of claim 1, wherein said first member defines a plurality of apertures, and wherein said vehicle further comprises a second member being selectively movable between a first position in which the second member does not protrude into the cargo area, and a second position in which portions of the second member protrude into the cargo area through respective ones of the apertures.

3. The vehicle of claim 2, wherein the surface of the first member has a first coefficient of friction, and wherein at least one of said portions of the second member has a second coefficient of friction different from the first coefficient of friction.

4. The vehicle of claim 2, wherein said portions of the second member are roller elements.

5. The vehicle of claim 2, further comprising an actuator operatively connected to the second member and configured to selectively cause the movement of the second member between the first and second positions.

6. The vehicle of claim 5, wherein the load floor is configured such that the actuator causes the second member to move from one of the first positon and the second position to the other of the first position and second position in response to the existence of at least one predetermined condition.

7. The vehicle of claim 6, wherein said at least one predetermined condition includes the vehicle moving.

8. The vehicle of claim 6, wherein the vehicle includes an engine, and wherein said at least one predetermined condition includes the engine running.

9. The vehicle of claim 6, wherein the vehicle includes an ignition switch selectively movable between an on position and an off position, and wherein said at least one predetermined condition includes the ignition switch being in the on position.

10. The vehicle of claim 6, wherein said at least one predetermined condition includes the vehicle being inclined more than a predetermined amount.

11. The vehicle of claim 2, further comprising a plurality of flexible members, each of said members being configured to extend across a respective one of said plurality of apertures when said second member is in the first position.

12. The vehicle of claim 2, further comprising a plurality of light sources, each being sufficiently positioned to selectively transmit light into the cargo area through a respective one of said portions of said second member.

13. The vehicle of claim 2, wherein said portions of said second member cooperate with each other and with the first member to define compartments to retain cargo when the second member is in the second position.

14. A load floor assembly for a vehicle cargo area comprising:
a first member defining a surface configured to at least partially define the cargo area and defining a plurality of apertures;
a second member being selectively movable with respect to the first member and having a plurality of protuberances each being aligned with a respective one of the plurality of apertures;
said second member being selectively movable between a first position in which the protuberances do not protrude above the surface of the first member, and a second position in which the protuberances protrude above the surface of the first member through said plurality of apertures.

15. The load floor assembly of claim 14, wherein said surface of the first member is characterized by a first coefficient of friction, and wherein the plurality of protuberances are characterized by a second coefficient of friction different from the first coefficient of friction.

16. The load floor assembly of claim 14, further comprising a plurality of roller elements, each of said roller elements at least partially defining a respective one of said plurality of protuberances.

17. The load floor assembly of claim 14, further comprising an actuator operatively connected to said second member and configured to selectively move said second member between the first and second positions.

18. A load floor assembly for a vehicle cargo area comprising:
a first member defining a surface configured to at least partially define the cargo area, characterized by a first coefficient of friction, and defining a plurality of apertures;
a second member being selectively movable with respect to the first member, said second member including a material characterized by a second coefficient of friction different from the first coefficient of friction;
said second member being selectively movable between a first position in which the material does not protrude above the surface, and a second position in which the material protrudes above the surface through said plurality of apertures; and
at least one light source being sufficiently positioned to transmit light through the material.
